(19) United States
(12) Patent Application Publication
(10) Pub. No.: US 2014/0370305 A1
(43) Pub. Date: Dec. 18, 2014

(54) PATTERNABLE MATERIALS AND METHODS OF USE

(71) Applicants: Maria Celeste Tria, Rochester, NY (US); Christine Joanne Landry-Coltrain, Fairport, NY (US)

(72) Inventors: Maria Celeste Tria, Rochester, NY (US); Christine Joanne Landry-Coltrain, Fairport, NY (US)

(21) Appl. No.: 13/915,729

(22) Filed: Jun. 12, 2013

(51) Int. Cl. B29C 59/00; B41N 3/03

(52) U.S. Cl. CPC B29C 59/002; B41N 3/03; B29K 2083/00
USPC 428/447; 428/336; 264/219; 264/400

(57) ABSTRACT

A patternable material can be prepared with an elastomeric relief image-forming layer. The patternable material has a relief image-forming elastomeric layer and also has a layer disposed on the entire surface of this elastomeric layer. This layer includes a reaction product of a non-fluorinated metal oxide precursor and a hydrolyzable fluoroalkylsilane. The reaction product is formed by applying a reactive composition of the noted components over the entire surface.

### RELATED APPLICATION

Copending and commonly assigned U.S. Ser. No. 13/______ filed on even date herewith by Tria and Landry-Coltrain, and entitled PATTERNED MATERIALS AND METHODS OF MAKING THEM (Attorney Docket K001424/JLT).

### FIELD OF THE INVENTION

This invention relates to patternable materials having relief image-forming layers and to methods for using them to prepare patterned materials with relief images.

### BACKGROUND OF THE INVENTION

Relief images can be provided and used in various articles for many different purposes. For example, the electronics, display, and energy industries rely on the formation of coatings and patterns of conductive materials to form circuits on organic and inorganic substrates. Such coatings and patterns are often provided using relief imaging methods and relief image forming elements. There is also need for means to provide fine wiring in various articles.

Contact printing is a non-lithographic method for forming patterned materials. Contact printing potentially provides a significant advance over conventional photolithographic techniques since contact printing can form relatively high resolution patterns for electronic parts assembly. Microcontact printing can be characterized as a high resolution technique that enables patterns of micrometer dimensions to be imparted onto a substrate surface. Contact printing is a possible replacement to photolithography in the fabrication of microelectronic devices, such as radio frequency tags (RFID), sensors, touch screen components, and memory and back panel displays. The capability of microcontact printing to transfer a self-assembled monolayer (SAM) forming molecular species to a substrate has also found application in patterned electroless deposition of metals. SAM printing is capable of creating high resolution patterns, but is generally limited to forming metal patterns of gold or silver for example using thiol chemistry. Although there are variations, in SAM printing a positive relief pattern provided on an element having a relief image is inked onto a substrate.

Flexography is a one method of printing or pattern formation that is commonly used for high-volume printing runs. It is usually employed for printing on a variety of soft or easily deformed materials including but not limited to, paper, paperboard stock, corrugated board, polymeric films, fabrics, and metal foils, and also including more rigid materials such as glass, glass-coated materials, flexible glass materials, and laminates of multiple materials. Coarse surfaces and stretchable polymeric films are economically printed using flexography.

Flexographic printing members are sometimes known as “relief” printing members (for example, relief-containing printing plates, printing sleeves, or printing cylinders) and are provided with raised relief images onto which ink is applied for application to a printable material. While the raised relief images are inked, the relief “floor” and “walls” should remain free of ink. The flexographic printing precursors are generally supplied with one or more imageable layers that can be disposed over a backing layer or substrate. Flexographic printing also can be carried out using a flexographic printing cylinder or seamless sleeve having the desired relief image.

Gravure or intaglio printing members are also relief printing members in which the image to be printed comprises depressions or recesses on the surface of the printing member, where the printing area is localized to the areas of depression that define the pattern or image. The process for using gravure or intaglio printing members is the reverse of flexographic relief printing wherein an image is raised above the floor of the flexographic printing member and the printing area is localized at the contact area of the top surface protrusions (uppermost ink-receptive surfaces).

During use of these various relief printing members, ink residue can accumulate over time in areas of the relief printing member that are not intended to hold ink especially when cleaning is not carried (or cannot be) out for each impression. This ink residue eventually transfers to receiver elements after some time creating inaccurate impressions. Ink accumulation on the sides of the raised relief images, such as in flexographic printing, can also result in printing defects such as dot gain or line broadening.

U.S. Patent Application Publication 2010/0112299 (Matsushita) describes a complicated process for treating relief images to reduce printing blemishes using an acrylic copolymer coating.

There is a need in the art to reduce or eliminate the problem caused by residue ink so that the relief printing members can be used repeatedly without the need for frequent cleaning operations. It is desired to reduce this problem in a simple fashion and to use a durable ink repelling layer that has high wearability, yet does not adversely affect the quality of the printing images.

### SUMMARY OF THE INVENTION

The present invention provides advantages described below so that the problem described above is avoided or minimized.

Thus, the present invention provides a patternable material comprising:
a relief image-forming elastomeric layer, and
a layer disposed on the relief image-forming elastomeric layer, the layer comprising a reaction product of a non-fluorinated metal oxide precursor and a hydrolyzable fluoroalkylsilane.

In addition, a method of this invention for providing a patterned material useful for printing, comprises:
providing a patternable material precursor comprising a relief image-forming elastomeric layer,
applying a reactive composition comprising a non-fluorinated metal oxide precursor and a hydrolyzable fluoroalkylsilane onto the entire surface of the relief image-forming elastomeric layer,
drying and curing the reactive composition to form a layer comprising a reaction product of a non-fluorinated metal oxide precursor and a hydrolyzable fluoroalkylsilane, and
providing a relief image comprising uppermost surfaces and relief recesses comprising recess walls and recess floors, and simultaneously removing the reaction product from the relief recesses while leaving the reaction product disposed only on the uppermost surfaces,
   to form a patterned material useful for printing.

The patterned material of any embodiment of this invention can be used for printing an image as described below. For example, this method for printing comprises:
providing a patterned material of any embodiment of this invention having a relief image,
applying a printable composition to the printing surface of the relief image, and
applying the printable composition on the printing surface of the relief image to a receiver element.

In the various embodiments of the present invention, it was found that ink residue on certain surfaces of relief images or patterned materials, which are repeatedly contacted with inks or functional materials to provide multiple impressions, can be reduced or eliminated by protecting those surfaces with a unique reaction product. These advantages are achieved by coating or modifying non-printing areas of the relief image with a hydrophobic/oleophobic fluorinated silicate layer that is prepared by in situ acid-catalyzed reaction of a reactive composition of a tri- or tetra-hydrolyzable silicon oxide precursor and a tri-hydrolyzable fluoroalkyl silicon oxide precursor. This reactive composition can be applied in various ways as described below, and if necessary, it can be removed from the printing areas in certain areas of the relief image prior to use.

The patternable materials of this invention include but are not limited to, flexographic printing members (in the form of plates, cylinders, or sleeves) including laser-engraveable flexographic printing members, intaglio printing members, and gravure printing members prepared from suitable elastomeric, relief-forming materials as described below.

Further details of the present invention are provided below to provide illustration of various embodiments of patternable members as well as various methods for preparing and using them.

### DETAILED DESCRIPTION OF THE INVENTION

### Definitions

As used herein to define various components of the elastomeric layer compositions, reaction products, and other components, formulations, or layers, unless otherwise indicated, the singular forms “a”, “an”, and “the” are intended to include one or more of the components (that is, including plurality referents).

Each term that is not explicitly defined in the present application is to be understood to have a meaning that is commonly accepted by those skilled in the art. If the construction of a term would render it meaningless or essentially meaningless in its context, the term definition should be taken from a standard dictionary.

The use of numerical values in the various ranges specified herein, unless otherwise expressly indicated otherwise, are considered to be approximations as though the minimum and maximum values within the stated ranges were both preceded by the word “about”. In this manner, slight variations above and below the stated ranges can be used to achieve substantially the same results as the values within the ranges. In addition, the disclosure of these ranges is intended as a continuous range including every value between the minimum and maximum values.

The term “alkyl group” refers to a linear, branched, or cyclic fully saturated hydrocarbon group having at least 1 carbon atom (at least 3 carbon atoms for branched groups and 4 carbon atoms for cyclic groups).

The term “alkylene group” refers to a linear, branched, or non-aromatic cyclic hydrocarbon groups having at least one carbon-carbon unsaturated group.

The term “fluoroalkyl” refers to an alkyl group wherein one or more of the hydrogen atoms in the group are replaced by fluorine atoms.

The term “elastomeric” refers to a material having the property of an elastomer. An elastomer is typically a polymer or resin that is crosslinked, either chemically or physically, and exists above its glass transition temperature, so that it has notably low Young's modulus and high yield strain and elongation or compression to break compared with other materials. It can undergo significant elongation without breaking and will return reversibly to its original form after the force is removed.

The term “flexographic printing precursor” refers to a patternable material of this invention that can be used to prepare a flexographic printing member (patterned member) of this invention and can be in the form of flexographic printing plate precursors, flexographic printing cylinder precursors, or flexographic printing sleeve precursors.

The term “flexographic printing member” refers to certain patterned material precursors that have been imaged and can be in various forms such as plates, cylinders, and sleeves. The flexographic printing member has a relief image in the outermost surface.

The term “patternable material” refers to the various articles of this invention that include but are not limited to, flexographic printing precursors and materials that can be patterned to provide mask elements, photoresists, patterned dielectrics, patterned 3-dimensional structures, patterned bather films, patterned molds including those for embossing and nanoimprinting applications, patterned microfluidic devices or structures, and lithographic plates or precursors. Such articles can be provided in any form, shape, or size, with or without a substrate. Moreover, such articles comprise the reaction product described herein over either part or the entire relief image surface.

The term “receiver element” refers to any material or substrate that can be printed with ink using a patterned material (for example, flexographic, intaglio, gravure printing member, or stamping member).

The “relief image-forming elastomeric layer” refers to the layer of the patternable material in which a relief image can be formed.

The term “relief image” refers to all of the topographical features provided in the patternable material by imaging and comprises uppermost surfaces that are designed to transfer a pattern of ink to a receiver element. The term “recess floor” refers to the bottom-most surfaces of the relief image. For example, the recess floors can be considered the maximum dry depth of the relief image from the uppermost surfaces and can be at least 50 μm and up to and including 1000 μm and typically at least 100 μm and up to and including 800 μm. The relief image generally includes relief recesses consisting of recess floors and recess walls that are not inked in a flexographic printing process, but conversely are filled with ink in a gravure or intaglio printing process.

Unless otherwise indicated, the term “weight %” refers to the amount of a component or material based on the total dry weight of the composition or layer in which it is located.

The term “binder” refers to the sum of all organic polymeric components, such as thermoplastic and thermoplastic elastomeric polymeric, or rubber components that are not in the form of discrete organic particles, within the relief image-forming layer.

Unless otherwise indicated, the term “reactive layer” refers to the dried and cured layer of the reaction product of a non-fluorinated metal oxide precursor and a hydrolyzable fluoroalkylsilane, as described below. In some instances, this reactive layer may be referred to only as the “reaction layer” or “layer” but in the proper context, they are meant to be the same thing. The “reactive composition” refers to the undried and unreacted formulation comprising the non-fluorinated metal oxide precursor and a hydrolyzable fluoroalkylsilane.

The term “treated” refers to a patterned material or patternable material precursor to which the reactive composition, as defined herein, has been applied and dried.

The term “untreated” refers to a patterned material or patternable material precursor to which the reactive composition has not been applied.

Unless otherwise indicated, the terms “functional material”, “printable composition”, and “ink” are used interchangeably.

### Reaction Products

The reaction products used in the present invention are formed in a reactive composition by hydrolysis and condensation of one or more non-fluorinated metal oxide precursors (first reactive component) and a hydrolyzable fluoroalkylsilane (second reactive component). More specifically, these reactions products can be formed from a hydrolyzable fluoroalkylsilane having three hydrolyzable groups and an uncharged non-hydrolyzable fluoroalkyl (or fluorinated alkyl) group.

Thus, the dried and cured reaction layer disposed on the relief image within the elastomeric layer comprises an acid-catalyzed reaction product of a non-fluorinated silicon oxide precursor and a hydrolyzable fluoroalkylsilane.

In particular, the non-fluorinated metal oxide precursor comprises at least three hydrolyzable groups per metal atom, wherein the hydrolyzable groups are selected from the group consisting of halogen, alkoxy, aryloxy, and carboxy groups.

For example, useful non-fluorinated metal oxide precursors can be defined by the formula MXₙ or MRXₙ₋₁ wherein M is silicon, titanium, boron, aluminum, zirconium, tin, germanium, tantalum, phosphorus, lead, arsenic, lanthanum, iron, indium, copper, yttrium, barium, magnesium, or mixtures thereof.

In these formulae, R is hydrogen or a substituted or unsubstituted alkyl group (linear or branched) having 1 to 20 carbon atoms, a substituted or unsubstituted alkene group (linear or branched) having 1 to 20 carbon atoms, or a substituted or unsubstituted aryl group having 6 or 10 carbon atoms in the aromatic ring.

In addition, in these formulae, X is a hydrolyzable group selected from the group consisting of halogen, alkoxy (having 1 to 20 carbon atoms), aryloxy (having 6 or 10 carbon atoms in the aromatic ring), carboxy, and N(R¹)₂ groups in which R¹ is hydrogen, a substituted or unsubstituted alkyl group, or a substituted or unsubstituted aryl group.

In the noted formulae, n is the valence of the metal.

The hydrolyzable groups (X) can be a halogen such as fluorine, chlorine, bromine or iodine with chlorine and fluorine being particularly useful. Useful alkoxy groups include but are not limited to, methoxy, ethoxy, propoxy, butoxy, and acetoxy. Useful aryloxy groups are substituted or unsubstituted phenoxy groups.

Particularly useful M metals include silicon, titanium, aluminum, boron, and zirconium with silicon being most useful. For example, useful non-fluorinated silicon oxide precursors can be defined by the formulas SiRX₃ or SiX₄, wherein R is as defined above and X is a halogen, alkoxy, aryloxy, or carboxy.

In some embodiments, when M is silicon, the reaction layer is a fluorinated silicate network obtained from an acid-catalyzed hydrolysis and condensation of a mixture of non-fluorinated silicon oxide precursors with three or four hydrolyzable groups (X) and a hydrolyzable fluoroalkylsilane with three hydrolyzable groups (X) and an uncharged non-hydrolyzable fluorinated alkyl group.

To ensure that the reactive composition forms a continuous film rather than discontinuous particulates, it is useful that at least 50 mol % of the non-fluorinated silicon oxide precursors contain four hydrolyzable groups. To increase the hydrophobic (oleophobic) property of the applied reactive composition, it is useful that at least 0.1 mol % of the silicon oxide precursors contain a fluorinated alkyl substituent.

In many embodiments, the molar ratio of one or more non-fluorinated metal (such as silicon) oxide precursors to one or more hydrolyzable fluoroalkylsilanes in the reactive composition is at least 1:0.001 and to and including 1:1, or at least 1:0.05 and to and including 1:0.25. As one would understand from this teaching, the reactive composition disposed on the elastomeric layer can comprise multiple different reaction products as described herein.

Non-hydrolyzable substituents that be included within the non-fluorinated silicon oxide precursor include but are not limited to, hydrogen, alkyl groups (such as methyl, ethyl, propyl, isopropyl, butyl, t-butyl, iso-butyl, pentyl, hexyl, cyclohexyl, octyl, octadecyl, hexadecyl, and dodecyl groups), alkene groups (such as methacrylate, vinyl, and methacryloxy), aryl groups (such as phenyl groups), arylene groups (such as phenylene groups), chloroalkyl groups (such as chloropropyl), aminoalkyl groups (such as aminopropyl, aminoethylaminopropyl, piperazinylpropyl, n-phenylaminomethyl, 3-(n-phenylamino)propyl, diethylaminomethyl, and diethylaminopropyl groups), epoxyalkyl groups (such as 3-glycidoxypropyl), and mercaptoalkyl groups (such as 3-mercaptopropyl). The alkyl groups can be further substituted with one or more of the same or different alkyl substituents, hydroxyl, acyl, oxo, alkoxy, and halo groups. In some substituents, one or more oxygen, sulfur, or nitrogen atoms are included inserted along an alkyl chain, which could further be defined as ether, thioether, or secondary amine groups, respectively.

Representative non-fluorinated metal oxide precursors include but are not limited to, aluminum n-butoxide, aluminum s-butoxide, aluminum t-butoxide, aluminum s-butoxide bis(ethyl-acetoacetate), aluminum s-butoxide ethyl-acetoacetate, aluminum ethoxide, aluminum ethoxyethoxyethoxide, aluminum isopropoxide, aluminum phenoxide, boron ethoxide, boron isopropoxide, titanium chloride, titanium isopropoxide, methyltitanium tri-isopropoxide, phenyltitanium tri-isopropoxide, titaniumallylacetoacetate-tri-isopropoxide, titanium butoxide, titanium isobutoxide, titanium chloride triisopropoxide, titanium ethoxide, zirconium t-butoxide, zirconium ethoxide, and zirconium isopropoxide.

Representative non-fluorinated silicon oxide precursors include but are not limited to, silicon alkoxides such as tetramethoxysilane, tetraethoxysilane, tetrapropoxysilane, tetraisopropoxysilane, tetrabutoxysilane, tetrakis(s-butoxy)silane, tetrakis(2-ethylbutoxy)silane, tetrakis(2-ethylhexoxy)silane, tetrakis(2-methoxyethoxy)silane, tetraphenoxysilane, triethoxysilanes and trimethoxysilanes, aminopropyltriethoxysilane, methyltrimethoxysilane, methacryloxypropyltrimethoxysilane, vinyltrimethoxysilane, phenyltrimethoxysilane, vinyltri-isopropoxysilane, phenyltriethoxysilane, allyltrimethoxysilane, allyltriethoxysilane, and trichlorosilanes (such as benzyltrichlorosilane, allyltrichlorosilane, and phenyltrichlorosilane).

The hydrolyzable fluoroalkylsilanes useful in the practice of this invention are silicon oxide precursors having three hydrolyzable groups and an uncharged non-hydrolyzable fluorinated alkyl substituent attached to the silicon atom. The hydrolyzable groups can be halogens, alkoxy, aryloxy, or carboxy groups (as defined above).

For example, the hydrolyzable fluoroalkylsilane can be represented by the formula:

R¹-R²—Si(X)₃

wherein R¹ is a fluoroalkyl group, R² is an aliphatic linking group connecting the fluoroalkyl group to Si, and X is a hydrolyzable group selected from the group consisting of halogen, alkoxy, aryloxy, and carboxy groups as described above. More particularly, R² can be represented by the formulae —(CH₂)ₙ—, —(CH₂)ₙCH—, and —(CH₂)ₙC—, depending upon the degree of branching, wherein n in these formulae is at least 1 and up to and including 3.

Non-hydrolyzable fluorinated alkyl substituents include but are not limited to, 3,3,3-trifluoropropyl, tridecafluoro-1,1,2,2-tetrahydrooctyl, heptadecafluoro-1,1,2,2-tetrahydrodecyl, nonafluorohexyl, and 5,5,6,6,7,7,8,8,9,9,10,10-tridecafluoro-2-(tridecafluorohexyl).

Typical hydrolyzable fluoroalkylsilanes useful in the practice of this invention include but are not limited to, fluoroalkyl alkoxysilanes, such as, 3,3,3-trifluoropropyltriethoxysilane, tridecafluoro-1,1,2,2-tetrahydrooctyltriethoxysilane, (heptadecafluoro-1,1,2,2-tetrahydrodecyl)triethoxysilane, (heptadecafluoro-1,1,2,2-tetrahydrodecyl)trimethoxysilane, nonafluorohexyltriethoxysilane, nonafluorohexyltrimethoxysilane, (tridecafluoro-1,1,2,2-tetrahydrooctyl)trimethoxysilane, 5,5,6,6,7,7,8,8,9,9,10,10-tridecafluoro-2-(tridecafluorohexyl)decyltrichlorosilane and fluoroalkylchlorosilanes, such as (perfluorodecyl)ethyltrichlorosilane, (heptadecafluoro-1,1,2,2-tetrahydrodecyl)trichlorosilane, nonafluorohexyltrichlorosilane, and (tridecafluoro-1,1,2,2-tetrahydrooctyl)trichlorosilane.

The reaction products (single or multiple reaction products in a reactive composition) useful in the practice of this invention can be prepared using the following general procedure and conditions:
(a) mixing one or more metal alkoxide precursors and a suitable solvent or mixture of solvents, such as alcohols such as ethanol, methanol, and isopropanol, or tetrahydrofuran;
(b) adding an aqueous acid, the molar ratio of acid to one or more metal alkoxide precursors being at least 0.0005 and up to and including 0.05 and the molar ratio of water to metal alkoxide precursor being at least 1 and up to and including 20;
(c) adding one or more fluorinated alkylsilanes, the molar ratio of the fluorinated alkylsilane(s) to the non-fluorinated metal alkoxide precursor(s) being at least 0.001 and up to and including 0.5;
(d) depositing by coating, dipping, spraying, or a similar application technique, the resulting reactive composition onto the element to be treated, such as the elastomeric layer; and
(e) drying and curing the reactive composition at a temperature of at least ambient temperature and up to and including 200° C. for a period of time sufficient to essentially remove the solvents and drive the condensation reaction of the metal oxide precursor(s) and fluorinated alkylsilane(s) to form one or more reaction products.

The first and second reactive components described herein and used in the present invention can be formulated and applied within a reactive composition that further comprises one or more polymers that can serve as binder materials before and after drying and curing.

Useful polymers or resins that can be used as binder materials in this manner include but are not limited to, polymers that are soluble or dispersible in ethanol or other water-miscible solvents such as tetrahydrofuran (THF). Representative polymers having this property include but are not limited to, polyvinyl butyral, poly(hydroxyethyl methacrylate), poly(vinyl pyridine), cellulose acetate butyrate, and polypropylene glycol, which are soluble in ethanol. Other useful polymers also include poly(acrylates), poly(methacrylates), polyurethanes, polyoxazolines, polyacrylamides, polymethacrylamides, and polydimethylsiloxanes, all of which are soluble in THF. Such binder polymers or resins are generally present in the reactive composition in an amount of up to and including 20 weight %, based on the total weight of the resulting dried layer.

The reactive composition can also include one or more optional addenda including but not limited to, humectants, surfactants, salts, plasticizers, colorants such as dyes or pigments, IR or near IR radiation absorbers, UV absorbers, fluorescent dyes, antioxidants, antiozonants, stabilizing compounds, dispersing aids, lubricating agents, thickening agents, and adhesion promoters, as long as they do not interfere with the formation of the reaction product or its intended purposes.

The first and second reactive components described above form the reaction product. Optional polymer binders, and other addenda can be formulated in a suitable reactive composition using one or more organic solvents such as ethanol, methanol, isopropanol, n-propanol, n-butanol, 2-ethoxyethanol, tetrahydrofuran, dioxane, formamide, and N,N-dimethylformamide. Mixtures of these organic solvents can also be used. The first and second reactive components used in the reactive composition are generally present in an amount of at least 1.5 weight % and up to and including 50 weight % of the solution weight. After drying and curing, as some of the reactions used to form a given reaction product may not go to 100% completion of the condensation reaction, a skilled worker can use routine experimentation to determine the optimum amounts of each reactive component in the reactive composition.

### Patternable Materials

The patternable materials of this invention comprise as essential components: (a) an elastomeric layer composed of materials described below in which a relief image can be formed, and (b) a layer that is disposed on only the uppermost surfaces of the elastomeric layer, which layer comprises the reaction product of a non-fluorinated metal oxide precursor and a hydrolyzable fluoroalkylsilane as described above, that is a reaction product of first and second reactive components.

In many embodiments, the layer (b) can comprise an acid-catalyzed reaction product of a non-fluorinated silicon oxide precursor and a hydrolyzable fluoroalkylsilane, and this layer has a dry thickness of at least 100 nm and up to and including 5,000 nm, or typically at least 200 nm and up to and including 2,000 nm, or even at least 500 nm and up to and including 1,000 nm.

The relief image-forming elastomeric layer (“elastomeric layer”) in the patternable material comprises one or more elastomeric resins as its primary or predominant component, such as one or more thermoplastic elastomeric resins, crosslinked elastomers or rubbery resins such as vulcanized rubbers. The elastomeric layer can be chemically crosslinked, physically crosslinked, or non-crosslinked. For example, the elastomeric layer can include one or more thermosetting or thermoplastic urethane resins that are derived from the reaction of a polyol (such as polymeric diol or triol) with a polyisocyanate, or the reaction of a polyamine with a polyisocyanate. In other embodiments, the elastomeric layer comprises a thermoplastic elastomer and one or more multifunctional monomers or oligomers that can be chemically reacted to form crosslinks by using thermal initiation or initiation via actinic radiation, such as UV radiation, to form a reaction product.

Further details of useful patternable materials used to provide patterned materials that are photosensitive flexographic printing plate precursors and are imaged through a mask are provided in U.S. Pat. No. 6,238,837 (Fan), U.S. Pat. No. 7,279,254 (Zwadlo), U.S. Pat. No. 7,799,504 (Zwadlo et al.), U.S. Pat. No. 8,142,987 (Ali et al.), and U.S. Pat. No. 8,153,347 (Veres et al.), the disclosures of all of which are incorporated herein by reference.

Other useful elastomeric layers comprise elastomeric resins that can be directly engraved using a suitable laser. Such elastomeric resins include but are not limited to, copolymers or styrene and butadiene, copolymers of isoprene and styrene, styrene-butadiene-styrene block copolymers, styrene-isoprene-styrene copolymers, other polybutadiene or polyisoprene elastomers, nitrile elastomers, polychloroprene, polyisobutylene and other butyl elastomers, any elastomers containing chlorosulfonated polyethylene, polysulfide, polyalkylene oxides, or polyphosphazenes, elastomeric polymers of (meth)acrylates, elastomeric polyesters, and other similar polymers known in the art. Still other useful polymers include polyisocyanate, polybutadiene or polyisoprene elastomers, nitrile polymers, and other similar polymers known in the art, or copolymers of any of the polymers described above.

Some laser-engraved elastomeric layers comprise one or more elastomeric laser-engraveable resins such as vulcanized rubbers for example EPDM (ethylene-propylene diene rubber), Nitrile (Bursa-N), Natural rubber, Neoprene or chloroprene rubber, silicone rubber, fluorocarbon rubber, fluorosilicone rubber, SBR (styrene-butadiene rubber), NBR (acrylonitrile-butadiene rubber), ethylene-propylene rubber, and butyl rubber.

Other useful laser-engraved resins comprise polymeric materials that, upon heating to 300° C. (generally under nitrogen) at a rate of 10° C./minute, lose at least 60% (typically at least 90%) of their mass and form identifiable low molecular weight products that usually have a molecular weight of 200 or less. Specific examples of such materials include but are not limited to, poly(cyanoacrylate)s that include recurring units derived from at least one alkyl-2-cyanoacrylate monomer and that forms such monomer as the predominant low molecular weight product during ablation. These polymers can be homopolymers of a single cyanoacrylate monomer or copolymers derived from one or more different cyanoacrylate monomers, and optionally other ethylenically unsaturated polymerizable monomers such as (meth)acrylate, (meth)acrylamides, vinyl ethers, butadienes, (meth)acrylic acid, vinyl pyridine, vinyl phosphonic acid, vinyl sulfonic acid, and styrene and styrene derivatives (such as α-methylstyrene), as long as the non-cyanoacrylate co-monomers do not inhibit the ablation process. The monomers used to provide these polymers can be alkyl cyanoacrylates, alkoxy cyanoacrylates, and alkoxyalkyl cyanoacrylates. Representative examples of poly(cyanoacrylates) include but are not limited to poly(alkyl cyanoacrylates) and poly(alkoxyalkyl cyanoacrylates) such as poly(methyl-2-cyanoacrylate), poly(ethyl-2-cyanoacrylate), poly(methoxyethyl-2-cyanoacrylate), poly(ethoxyethyl-2-cyanoacylate), poly(methyl-2-cyanoacrylate-co-ethyl-2-cyanoacrylate), and other polymers described in U.S. Pat. No. 5,998,088 (Robello et al.) the disclosure of which is incorporated herein by reference.

In still other embodiments, the elastomeric layer includes laser-engraved materials that are alkyl-substituted polycarbonate or polycarbonate block copolymers that form a cyclic alkylene carbonate as the predominant low molecular weight product during depolymerization from engraving. The polycarbonate can be amorphous or crystalline, and can be obtained from a number of commercial sources including Aldrich Chemical Company (Milwaukee, Wis.). Representative polycarbonates are described for example in U.S. Pat. No. 5,156,938 (Foley et al.), Cols. 9-12 the disclosure of which is incorporated herein by reference. Representative polycarbonates include poly(propylene carbonate) and poly(ethylene carbonate).

Still other laser-engravable materials for forming relief images are described in U.S. Pat. No. 8,114,572 (Landry-Coltrain et al.) and U.S. Pat. No. 8,163,465 (Regan et al.), the disclosures of which are incorporated herein by reference.

Some elastomeric layers include a mixture of ethylene-propylene-diene terpolymer (EPDM) rubbers including at least one high molecular weight EPDM resin and at least one low molecular weight EPDM resin. The high EPDM rubbers generally have a molecular weight of at least 200,000 and up to and including 800,000 and more typically at least 250,000 and up to and including 500,000. The high molecular weight rubbers are generally solid form and the molecular weight is at least 30 times (or even 50 times) higher than that of the low molecular weight EPDM rubbers. The high molecular weight EPDM rubbers can be obtained as Keltan® EPDM (from DSM Elastomers) and Royalene® EPDM (from Lion Copolymers).

The low molecular weight EPDM rubbers are usually in liquid form, and having a molecular weight of at least 2,000 and up to and including 10,000 and typically at least 2,000 and up to and including 8,000. A useful low molecular weight EPDM rubber is available as Trilene® EPDM (from Lion Copolymers).

Further, the elastomeric layer can include one or more nanocrystalline polyolefins. Useful nanocrystalline polyolefins include but are not limited to homopolymers of ethylenically unsaturated olefin hydrocarbons having 2 to 20 carbon atoms and typically from 2 to 8 carbon atoms. Such unsaturated α-olefins having at least 3 carbon atoms can have various linear or branched alkyl side chains, and any of the olefins can have other side chains provided that the side chains do not adversely affect the polyolefin morphology or thermoplastic and elastomeric properties. Useful commercial examples of nanocrystalline polyolefins are found as the Notio™ products from Mitsui Chemicals America, Inc., Rye Brook, N.Y., and as the Engage™ products from Dow Chemical Ayer, MA. Other useful thermoplastic elastomers include olefinic block copolymers, such as those sold under the name Dynalloy™ products by PolyOne GLS Thermoplastic Elastomers of PolyOne Corporation, and Infuse™ products available from Dow Chemical.

Still other useful nanocrystalline polyolefins can be prepared using known synthetic procedures as described, but not limited to, for example in U.S. Pat. No. 6,930,152 (Hashimoto et al.) and U.S. Pat. No. 7,253,234 (Mori et al.), and U.S. Patent Application Publication 2008-0220193 (Tohi), the disclosures of all of which are incorporated herein by reference.

Other useful elastomeric resins are any of the above-listed polymers that are available, or can be prepared, as aqueous latex, dispersions, emulsions, or suspensions. Examples include but are not limited to, acrylic polymer emulsions and aqueous polyurethane resins from Picassian Polymers, aqueous poly(propylene carbonate) dispersion from Empower Materials, DE, styrene butadiene rubber (SBR) emulsions, as sold by Dow Chemical and BASF, polyurethane dispersions from Witco Corporation. Other useful examples include styrene-acrylic copolymer emulsions, polydimethylsiloxane (PDMS) and PDMS copolymer emulsions, SBR, SEBR, and EPDM emulsions or dispersions, dispersions of polyethylene, polypropylene, and copolymers of these with (meth)acrylic acid.

Still other useful compositions for elastomeric layers are described in U.S. Patent Application Publications 2013/0001832 (Melamed et al.) and 2013/0074718 (Gal et al.), the disclosures of which are incorporated herein by reference. These compositions comprise one or more CLCB EPDM elastomeric resins as well as one or more infrared radiation absorbing compounds and optionally one or more peroxides.

The relief image-forming elastomeric layer comprises the thermoplastic elastomeric resins, crosslinked elastomers, or rubbery resins such as vulcanized rubbers, in an amount of at least 20 weight % and up to and including 95 weight %, or typically at least 50 weight % and up to and including 90 weight %, based on the total dry elastomeric layer weight.

In some embodiments, the elastomeric layer can further comprise one or more infrared radiation (IR) absorbing compounds to provide absorption at a near-IR or IR wavelength of at least 700 nm and up to and including 1500 nm. Such infrared radiation absorbing compounds can be in the form of metal particles, a dye or a pigment that absorbs the laser energy and converts exposing photons into thermal energy. Useful IR dyes typically have a specific absorption peak that will overlap with the laser radiation wavelength. Pigments such as a conductive or non-conductive carbon black have absorption properties that are panchromatic over the entire near infrared spectrum.

The elastomeric layer can comprise one or more infrared radiation absorbing compounds in a total amount of at least 0.5 weight % and up to and including 35 weight %, and particularly at least 3 weight % and up to and including 15 weight %, based on total dry elastomeric layer weight.

Particularly useful infrared radiation absorbing compounds include carbon blacks and other IR-absorbing organic or inorganic pigments (including squarylium, cyanine, merocyanine, indolizine, pyrylium, metal phthalocyanines, and metal dithiolene pigments), and iron oxide and other metal oxides. Additional useful infrared radiation absorbing compounds include carbon blacks that are surface-functionalized with solubilizing, compatibilizing, or hydrophobic groups that are well known in the art. Carbon blacks that are grafted to hydrophilic, nonionic polymers, such as FX-GE-003 (manufactured by Nippon Shokubai), or which are surface-functionalized with anionic groups, such as CAB-O-JET™ 200 or CAB-O-JET® 300 (manufactured by the Cabot Corporation) are also useful. Examples of useful carbon blacks include Mogul® L, Mogul® E, Emperor® 2000, Vulcan® XC-72, Sterling® C, Black Pearls® 700 and 1300, Monarch® 800 and 1400, and Regal®330, and 400, all from Cabot Corporation (Boston Mass.). Other useful pigments include, but are not limited to, Heliogen Green, Nigrosine Base, iron (III) oxides, transparent iron oxides, magnetic pigments, manganese oxide, Prussian Blue, and Paris Blue. Other useful infrared radiation absorbing compounds are carbon nanotubes such as single- and multi-walled carbon nanotubes, graphite, graphene, and porous graphite. Examples of useful graphenes include, but are not limited to, xGnP graphene nanoplatelets from XG Sciences, MI, including Grade M particles and Vor-X functionalized graphene nanosheets from Vorbec Materials, MD, and graphene from Graphene Industries (UK) and Graphene Laboratories (MA).

Useful infrared radiation absorbing organic dyes having a λₘₐₓ of at least 800 nm are described in U.S. Pat. No. 4,912,083 (Chapman et al.), U.S. Pat. No. 4,942,141 (DeBoer et al.), U.S. Pat. No. 4,948,776 (Evans et al.), U.S. Pat. No. 4,948,777 (Evans et al.), U.S. Pat. No. 4,948,778 (DeBoer), U.S. Pat. No. 4,950,639 (DeBoer et al.), U.S. Pat. No. 4,950,640 (Evans et al.), U.S. Pat. No. 4,952,552 (Chapman et al.), U.S. Pat. No. 4,973,572 (DeBoer), U.S. Pat. No. 5,036,040 (Chapman et al.), and U.S. Pat. No. 5,166,024 (Bugner et al.) the disclosures of all of which are incorporated herein by reference.

The elastomeric layer can further comprise crosslinked or non-crosslinked organic porous particles that generally have a mode particle size of at least 2 μm and less than 100 μm, or typically at least 5 μm and up to an including 70 μm, with this mode particle size being measured by automated image analysis and flow cytometry using any suitable equipment designed for this purpose. Such crosslinked and non-crosslinked organic porous particles can also have small colloidal inorganic particles on the external particle surfaces. Such colloidal inorganic particles can be composed of colloidal silica, colloidal alumina, colloidal titania, clay particles, or mixtures thereof.

The elastomeric layer can further comprise chemically inactive particles or microparticles in an amount of at least 2 weight % and up to and including 50 weight %, or typically at least 5 weight % and up to and including 25 weight %, based on total dry elastomeric layer weight. The term “inactive” means that the particles or microparticles are chemically inert and their presence can reinforce the mechanical properties of the elastomeric layer, increase its hardness, decrease its tackiness, or decrease the tackiness of the ablation debris.

Inactive inorganic particles include various inorganic filler materials including but not limited to, silica, titanium dioxide, and alumina, and particles such as fine particulate silica, fumed silica, porous silica, barium sulfate, calcium carbonate, calcium sulfate, zinc oxide, mica, talc (magnesium silicate hydrate), surface treated silica (sold as Aerosil from Degussa and Cab-O-Sil from Cabot Corporation), zeolites, and silicate minerals and clays such as bentonite, montmorillonite, and kaolinite, aluminum silicates, halloysite and hallosite nanotubes, and micropowders such as amorphous magnesium silicate cosmetic microspheres sold by Cabot and 3M Corporation.

Optional addenda in the elastomeric layer can also include but are not limited to, non-porous polymeric particles, plasticizers, colorants such as dyes and pigments, antioxidants, antiozonants, stabilizing compounds, dispersing aids, surfactants, thickening agents, and adhesion promoters, as long as they do not interfere with laser-engraving efficiency, or with the photoimaging efficiency. Examples of plasticizers can include low molecular weight polyolefins, polyesters, or polyacrylates, fluorinated compounds, silicone compounds, un-crosslinked liquid rubbers and oils, liquid ethylene-propylene, liquid polybutene, liquid polyisoprene, liquid polypropylene, or mixtures of these.

The elastomeric layer can be formed from a formulation comprising one or more elastomeric resins and additional components such as an infrared radiation absorbing compound and other additives, and optionally one or more coating solvents, to provide an elastomeric composition. Alternatively, the components can be suspended or dispersed in an aqueous medium. This formulation can be formed as a self-supporting layer or disposed on a suitable substrate (described below). Such layers can be formed in any suitable fashion, for example by coating, flowing, spraying, or pouring a series of formulations onto the substrate by methods known in the art and drying to form a layer, flat or curved sheet, or seamless printing sleeve. Alternatively, the formulations can be press-molded, injection-molded, melt extruded, co-extruded, or melt calendared into an appropriate layer or ring (sleeve), and optionally adhered or laminated to a substrate and cooled to form a layer, flat or curved sheet, or seamless printing sleeve and optionally cured or vulcanized. Some patterned members such as flexographic printing plates in sheet-form can be wrapped around a printing cylinder and optionally fused at the edges to form a seamless flexographic printing sleeve.

The patterned materials can include a self-supporting elastomeric layer comprising a relief image (defined above). This type of elastomeric layer does not need a separate substrate to have physical integrity and strength. In such embodiments, the elastomeric layer is thick enough so that the relief image depth is less than the entire dry thickness, for example up to 80% of the entire dry thickness, of the elastomeric layer.

The total dry thickness of the patternable materials of this invention, especially in the form of flexographic printing plate precursors, is at least 500 μm and up to and including 6,000 μm or typically at least 1,000 μm and up to and including 3,000 μm. Flexographic printing sleeve precursors can generally have an elastomeric layer comprising a relief image of at least 2 mm and up to and including 20 mm dry thickness. Flexographic printing cylinder precursors would also have a suitable relief image in the elastomeric layer.

The elastomeric layer comprising the relief image can be composed of multiple sub-layers of the same or different composition, if desired. These multiple sub-layers can be disposed one on top of the other in order to create a thicker elastomeric layer.

In some embodiments, the relief image-forming elastomeric layers are disposed over a suitable dimensionally stable, non-relief image-forming substrate (or “substrate”) having an imaging side and a non-imaging side. The substrate has at least one elastomeric layer (described above) disposed over the substrate on the imaging side. In most embodiments, the elastomeric layer is disposed directly on the substrate. Suitable substrates include but are not limited to, dimensionally stable polymeric films, aluminum sheets or cylinders, fiberglass forms, transparent forms, ceramics, woven and non-woven fabrics, glass, flexible glass, or laminates of polymeric films (from condensation or addition polymers) and metal sheets such as a laminate of a polyester and aluminum sheet or polyester/polyamide laminates, a laminate of a polyester film and a compliant or adhesive support, or a laminate of a polyester and a woven or non-woven fabric. A polyester, polycarbonate, vinyl polymer, or polystyrene film can be used. Useful polyesters include but are not limited to poly(ethylene terephthalate) and poly(ethylene naphthalate). The substrates can have any suitable thickness, but generally they are at least 0.01 mm or at least 0.05 mm and up to and including 0.3 mm thick (dry thickness), especially for the polymeric substrates, or up to 0.6 mm thick for woven or non-woven fabrics, or laminates of fabrics and polymeric supports. An adhesive layer can be used to secure an elastomeric layer to the substrate. A thin conductive layer or film of, for example, poly(3,4-ethylenedioxy-thiophene) (PEDOT), polyacetylene, polyaniline, polypyrrole, or polythiophenes, indium tin oxide (ITO), and graphene, can be disposed between the substrate and the elastomeric layer.

There can be a non-relief image-forming back coat on the non-imaging side of the substrate that can be composed of a soft rubber or foam, or other compliant layer. In addition, this back coat can be reflective of relief image-forming radiation or transparent to it. If desired, the back coat can also be imageable for example by laser-engraving to record specific information or metadata.

The patternable materials can contain one or more layers but the simplest useful embodiments consist essentially of the relief image-forming elastomeric layer and the layer of reaction product disposed on at least part of that elastomeric layer. In other embodiments, there can be a non-relief image-forming elastomeric layer (for example, a cushioning layer) between a substrate and the relief image-forming elastomeric layer.

### Methods for Making Patterned Materials

The present invention provides patternable materials for a variety of uses in which a relief image is needed for applying a suitable printable composition or functional material (described below).

For example, in some embodiments, a patternable material comprises:
a relief image-forming elastomeric layer (as described above) comprising uppermost surfaces and relief recesses comprising recess walls and recess floors, and a dried layer (or reaction product layer) disposed on the entire surface of the elastomeric layer, the dried layer comprising a reaction product of a non-fluorinated metal oxide precursor and a hydrolyzable fluoroalkylsilane (as described above, the details of which are incorporated for this description of the patterned materials). This layer containing the reaction product can further comprise a polymer binder (as described above) in an amount of up to and including 20 weight %, based on the total dry layer weight.

In some embodiments, the dry layer disposed on the entire elastomeric layer, comprises an acid-catalyzed reaction product of a non-fluorinated silicon oxide precursor and a hydrolyzable fluoroalkylsilane, and this layer has a dry thickness of at least 100 nm and up to and including 5,000 nm. These patternable materials can be flexographic, intaglio, or gravure printing member precursors having a plate, sleeve, or cylinder format. In addition, they can have an elastomeric layer disposed on a non-relief image-forming substrate (as described above).

In such embodiments, the layer comprising the reaction product is disposed on the entire outer surface of the elastomeric layer (and relief image), and thus it is disposed on the uppermost surfaces and well as the relief recesses comprising the recess walls and recess floors of the relief image. In some instances, it is desirable to remove the layer comprising the reaction product from only the uppermost surface of the relief image in a suitable manner prior to the relief image being used for printing, leaving reaction product disposed on the relief recesses (recess walls and recess floors) only. This layer removal can be accomplished in any suitable manner including but not limited to, laser ablation, etching, mechanical grinding, polishing, or a combination of these operations, so that at least 95% of the original amount of layer comprising the reaction product is removed from the uppermost surface of the relief image in the elastomeric layer.

Such laser ablation for this layer removal can be carried out by irradiating only the uppermost surface using a high-powered CO₂ laser until the layer comprising the reaction product is ablated away.

Layer removal by etching can be carried out by rubbing the uppermost surfaces of the relief image with a wet etchant such as potassium hydroxide, sodium hydroxide, or a hydrofluoric or nitric acid based solution until the layer comprising the reaction product is sufficiently removed.

Layer removal by mechanical grinding can be carried out by using a flat abrasive substance, such as common sand paper, or a rotating abrasive wheel, containing common abrasive materials include aluminum oxide, silicon oxide, silicon carbide, diamond, and cubic boron nitride (CBN).

Layer removal by polishing can be carried out similarly, by mechanical grinding, using a finer grit abrasive material and one or more rotating abrasive heads, flat abrasive substance, or rotating abrasive wheels.

Thus, the patterned materials provided in this manner can comprise an elastomeric layer comprising a relief image comprising uppermost surfaces and relief recesses comprising recess walls and recess floors, and a layer (comprising reaction product) disposed on only the recess walls and recess floors of the elastomeric layer. This layer comprises a reaction product of a non-fluorinated metal oxide precursor and a hydrolyzable fluoroalkyl silane for example, an acid-catalyzed reaction product of a non-fluorinated silicon oxide precursor and a hydrolyzable fluoroalkylsilane as described above. Such layer that is disposed on only the recess walls and recess floors generally has a dry thickness of at least 100 nm and up to and including 5,000 nm.

Patterned materials of this type can be provided, for example, by firstly providing a patterned material precursor comprising an elastomeric layer comprising a relief image comprising uppermost surfaces and relief recesses comprising recess walls and recess floors. Useful patterned material precursors can be provided in several ways as described herein, for example, by irradiation with actinic light of the relief image-forming elastomeric layer through a mask element to provide exposed regions and non-exposed regions in the elastomeric layer, or by direct laser engraving of the relief image-forming elastomeric layer, followed by removal of the unexposed areas using appropriate wicking or washing, followed by drying, as is well known in the flexographic art.

A reactive composition comprising a non-fluorinated metal oxide precursor and a hydrolyzable fluoroalkylsilane (such as a reactive composition comprises an acid-catalyzed non-fluorinated silicon oxide precursor and a hydrolyzable fluoroalkylsilane), as described above, is then applied over the entire relief image (on all of the uppermost surfaces, recess walls, and recess floors) of the patterned material precursor to form a wet reactive composition layer. This reactive composition application can be achieved by spraying, coating, dipping, bead-coating, or rolling.

After this application, the applied reactive composition is dried and cured to form a dry layer and causing reaction and formation of the reaction product from the first and second reactive components in the reactive composition. Drying and curing can be carried out in separate or simultaneous operations, and in the same or different equipment. For example, drying can be carried out by applying heat or air circulation, or both, using infrared or microwave radiation. Curing can be carried out in addition to drying for example at a temperature of at least room temperature but more likely of at least 50° C. and up to and including 200° C., or typically at a temperature of at least 60° C. and up to and including 120° C. In most instances, conditions and equipment are used to dry and cure simultaneously.

In some embodiments, the resulting reaction product can be removed from only the uppermost surfaces of the relief image, leaving the reaction product disposed only on the recess walls and recess floors. This removal can be achieved using laser ablation, etching, mechanical grinding, polishing, or a combination of these operations as described above.

In still other embodiments, a method provides a patterned material comprising an elastomeric layer comprising a relief image comprising uppermost surfaces and relief recesses comprising recess walls and recess floors (as described above). The relief image can be provided by irradiation with actinic light of the elastomeric layer through a mask element to provide exposed regions and non-exposed regions in the elastomeric layer, and removing the non-exposed regions of the elastomeric layer. Alternatively, the relief image can be provided by direct laser engraving. The resulting patterned material precursor can be a flexographic, intaglio, or gravure printing member having a plate, sleeve, or cylinder format. These methods for forming a relief image are described above along with cited publications with considerable details that would provide sufficient teaching to a skilled artisan.

In some embodiments, the uppermost surfaces of the relief image formed in the elastomeric layer of such patterned material precursors are then protected with a non-reactive protective layer that does not contain the reaction product described herein. The recess walls and recess floors of the elastomeric layer are not protected in this manner. Such non-reactive protective layers can comprise one or more suitable binder resins including but not limited to, cellulose acetate butyrate, Kynar (polyvinylidene fluoride (PVDF) homopolymer or copolymer), polystyrene, polyvinylidene chloride (PVDC), polyvinyl acetate, polybutadiene, polyurethane, poly(methyl methacrylate), poly(t-butyl methacrylate), poly(methyl acrylate), poly(n-butyl acrylate), poly(glycidyl methacrylate), poly(acrylamide), poly(vinyl benzyl chloride), polycaprolactone polyisoprene, and polyethylene oxide. A non-reactive protective layer formulation including one or more polymers and a suitable solvent can be applied using any suitable procedure such as by coating, gravure printing, or using an anilox roller in a flexographic mode, onto only the uppermost surfaces of the relief image. After application, the non-reactive protective layer coating can be dried in a suitable manner such as applying heat or air circulation, or both, using infrared radiation.

Once the uppermost surfaces are protected, a reactive composition comprising a non-fluorinated metal oxide precursor and a hydrolyzable fluoroalkylsilane (for example, comprising an acid-catalyzed non-fluorinated silicon oxide precursor and a hydrolyzable fluoroalkylsilane), as described above, can be applied onto all surfaces of the relief image in the elastomeric layer using a suitable technique described above and suitably dried and cured. For example, curing can be carried out at a temperature of at least 50° C. and up to and including 200° C. The reactive composition can be applied, dried, and cured to provide a dry layer of the reaction product having a dry layer thickness of at least 100 nm and up to and including 5,000 nm.

Following this operation, the non-reactive protective layer can be removed from part or all of the surfaces of the relief image, but in most embodiments, the protective layer is removed from only the uppermost surfaces of the relief images, leaving the reaction product on the recess walls and recess floors of the relief image. The non-reactive protective layer can be removed from the uppermost surfaces of the relief image, for example, by laser ablation, etching, solvent washing, mechanical grinding, polishing, or a combination of these operations, which operations are described in more detail above.

In other embodiments, the patterned material comprises an elastomeric layer comprising a relief image comprising uppermost surfaces and relief recesses comprising recess walls and recess floors, and a layer (comprising reaction product) is disposed on only the uppermost surfaces of the elastomeric layer. This layer comprises a reaction product of a non-fluorinated metal oxide precursor and a hydrolyzable fluoroalkyl silane, for example an acid-catalyzed reaction product of a non-fluorinated silicon oxide precursor and a hydrolyzable fluoroalkylsilane (as described above). Such layer disposed on only the uppermost surfaces of the elastomeric layer can have a dry thickness of at least 100 nm and up to and including 5,000 nm.

In other embodiments, a method comprises providing a patternable material comprising a relief-forming elastomeric layer as described above. The patternable material can be a flexographic, intaglio, or gravure printing precursor having a plate, sleeve, or cylinder format. No relief image is yet formed in this patternable material. To this patternable material, a reactive composition comprising a non-fluorinated metal oxide precursor and a hydrolyzable fluoroalkylsilane (for example, comprising an acid-catalyzed non-fluorinated silicon oxide precursor and a hydrolyzable fluoroalkylsilane), as described above, is applied onto the entire surface of the relief-forming elastomeric layer.

After the reactive composition is applied, it is dried and cured to form a dry layer comprising a reaction product of a non-fluorinated metal oxide precursor and a hydrolyzable fluoroalkylsilane (or a reaction product of a non-fluorinated silicon oxide precursor and a hydrolyzable fluoroalkylsilane). This dry layer comprising the reaction product can have a dry thickness of at least 100 nm and up to and including 5,000 nm. The reactive composition application, drying, and curing can be carried out using techniques as described above.

The reaction product is then removed simultaneously while providing a relief image in the relief image-forming elastomeric layer, the relief image comprising uppermost surfaces and relief recesses comprising recess walls and recess floors. The relief image can be provided and the reaction product removed wherein imaging occurs, by irradiation with actinic light through a mask element to provide exposed regions and non-exposed regions in the elastomeric layer, followed by removal of the non-exposed areas using appropriate wicking, development, or washing, followed by drying. Alternatively, the relief image can be provided and the reaction product removed using direct laser engraving of the relief image-forming elastomeric layer, leaving the reaction product disposed only on the uppermost surfaces of the relief image.

A method for providing a patterned material comprises:
providing a patterned material precursor comprising an elastomeric layer comprising a relief image comprising uppermost surfaces and relief recesses comprising recess walls and recess floors,
protecting only the uppermost surfaces of the relief image with a non-reactive protective layer,
applying a reactive composition comprising a non-fluorinated metal oxide precursor and a hydrolyzable fluoroalkylsilane onto the entire surface of the patterned material precursor,
drying and curing the reactive composition to form a reaction product over the entire relief image, and
removing the protective layer from the uppermost surfaces of the relief image, leaving the reaction product disposed on only the recess walls and floors.

For example, this method can comprise protecting the uppermost surfaces of the relief image by coating, gravure printing, or using an anilox roller in a flexographic mode only the uppermost surfaces of the relief image to form a non-reactive protective layer, and drying the non-reactive protective layer.

Alternatively, the method comprises:
removing the non-reactive protective layer from the uppermost surfaces of the relief image, by laser ablation, etching, solvent washing, mechanical grinding, polishing, or a combination of these operations.

In addition, the method can comprise:
providing the patterned material precursor by irradiation with actinic light of the elastomeric layer through a mask element to provide exposed regions and non-exposed regions in the elastomeric layer, and
removing the non-exposed regions of the elastomeric layer.

Or, the method comprises:
providing the patterned material precursor by direct laser engraving of the elastomeric layer.

In some embodiments, the method comprises removing the non-reactive protective layer only from the uppermost surfaces of the relief image.

### Methods for Using Patternable Materials

Relief images can be provided in relief image-forming elastomeric layers using various techniques. For example, as noted above in more detail, the relief image-forming elastomeric layer can be designed for crosslinking when imaged through a suitable mask element as is common for some commercial flexographic printing plate precursors such as those described in U.S. Pat. No. 8,142,987 (noted above), and U.S. Pat. Nos. 5,804,353 and 5,798,202 (both Cushner et al.), and in copending and commonly assigned U.S. Ser. No. 13/865,414 (filed Apr. 18, 2013 by Kidnie), the disclosures of all of which are incorporated herein by reference. Some commercially available flexographic printing plate precursors that can be used to form patternable materials are commercially available under the tradenames Flexcel flexographic printing plates (Eastman Kodak Company) and Cyrel® flexographic printing plates (DuPont).

Also as noted above in more detail, a relief image can be provided by direct laser-engraving using suitable laser-engraving with one or more suitable lasers. The resulting relief image can have a geometric feature, or a plurality of relief features, or it can be irregular in shape or appearance. Laser engraving to provide a relief image with a depth of at least 100 μm is desired with a relief image having a maximum depth of from about 300 μm and up to and including 1000 μm being more desirable.

One or more laser-engraving radiation sources can be selected from the group consisting UV, visible light, or infrared radiation lasers, gas CO₂ lasers, laser diodes, multi-emitter laser diodes, laser bars, laser stacks, fiber lasers, and a combination thereof. In some embodiments, the relief image-forming elastomeric layer of the patternable material comprises an infrared radiation absorber and the one or more laser-engraving radiation sources provide direct engraving infrared radiation. Other systems for providing relief images by laser-engraving are described for example in U.S. Pat. No. 6,150,629 (Sievers) and U.S. Pat. No. 6,857,365 (Juffinger et al.) and in U.S. Patent Application Publications 2006/0132592 (Sievers), 2006/0065147 (Ogawa), 2006/0203861 (Ogawa), and 2008/0153038 (noted above), 2008/018943A1 (noted above), and 2011/0014573A1 (noted above), the disclosures of all of which are incorporated herein by reference.

For example, a laser operating at a wavelength of at least 700 nm can be generally used, and a laser operating at a wavelength of at least 800 nm and up to and including 1250 nm is particularly useful. Generally, relief image-formation using laser-engraving is achieved using at least one laser providing a minimum fluence level of at least 1 J/cm² at the patternable material precursor topmost surface and typically infrared laser-engraving is carried out at an energy of at least 20 J/cm² and up to and including 1000 J/cm² or at least 50 J/cm² and up to and including 1500 J/cm². For example, infrared laser-engraving can be carried out using a diode laser, an array of diode lasers connected with fiber optics, a Nd-YAG laser, a fiber laser, a carbon dioxide gas laser, or a semiconductor laser. Such instruments and conditions for their use are well known in the art and readily available from a number of commercial sources. Detailed descriptions can be found in U.S. Patent Application Publications 2010/0068470A1 (Sugasaki), 2008/018943A1 (Eyal et al.), and 2011/0014573A1 (Matzner et al.) all the disclosures of which are hereby incorporated by reference.

The relief image forming system can further comprise a platform on which the patternable material precursor is mounted for laser-engraving. Such platforms can include for example, webs (moving or not moving), cylinders, or rotating drums. The laser-engraving infrared radiation sources can be provided as one or more lasers for example from a hybrid optical imaging head having at least two groups of radiation sources as described for example in U.S. Patent Application Publication 2008/0153038 (Siman-Tov et al.), the disclosure of which is incorporated herein by reference, that are controlled using suitable control devices.

Laser-engraving to form a relief image can occur in various contexts. For example, sheet-like flexographic printing members can be imaged and used as desired, or wrapped around a printing cylinder or cylinder form before imaging. The flexographic printing member can also be a printing sleeve that can be mounted directly into a laser imaging device.

During imaging to form a relief image, most of the removed products of laser-engraving are combinations of particulate and gaseous or volatile components and are readily collected by vacuum for disposal or chemical treatment. Any residual solid debris on the patterned material can be similarly collected using vacuum or washing.

After relief image formation, the resulting patterned material precursor can be subjected to an optional detacking step if the outermost surface of the relief image-forming elastomeric layer surface is still tacky, using methods known in the art, before application of a reactive composition on some or all of the relief image surfaces.

### Printing Processes

The patterned materials of the present invention can be used to print a suitable pattern of a functional material (or printable composition) on a receiver element. The present invention enables printing of a variety of functional materials over relatively large areas with desirable resolution (for example, less than 20 μm or even less than 10 μm) wherein “resolution” refers to the minimum dot diameter or line width of the printed feature. In some embodiments, where the functional material is an electrically conductive functional material, the resolution can be as low as 1 to 5 μm. The printing method also provides a means for printing sequential overlays without hindering the utility of one or more underlying layers. The method can be adapted to high-speed production processes for the fabrication of electronic devices and components.

For example, the method for printing using a patterned material comprises:
providing a patterned material comprising an elastomeric layer comprising a relief image comprising uppermost surfaces and relief recesses comprising recess walls and recess floors, wherein surfaces of the relief recesses, and optionally the uppermost surfaces, further comprise a dry layer comprising a reaction product of a non-fluorinated metal oxide precursor and a hydrolyzable fluoroalkylsilane (such as an acid-catalyzed reaction product of a non-fluorinated silicon oxide precursor and a hydrolyzable fluoroalkylsilane as described above), using any of the methods and procedures described herein, wherein the layer comprising the reaction product has a dry thickness of at least 100 nm and up to and including 5,000 nm,
applying a printable composition (described below) to the relief image (one or more times in sequence), and
applying the printable composition on the relief image to a receiver element using any suitable printing operation and conditions, for one or more printing impressions.

The patterned material used for printing can be a flexographic, intaglio, or gravure printing member having a plate, sleeve, or cylinder format.

The functional materials in printable compositions that can be printed according to the invention include, but are not limited to, inks, such as those designed for flexographic or gravure printing, including colored pigments, a carbon black ink, an ink containing graphene or carbon nanotubes, a metallic ink or paste, a masking material, a polymer, a conducting polymer, a composition containing a seed component for electroless plating, such as palladium, platinum, nickel, gold, silver, or copper metals or ions. Generally, the printable composition includes one or more functional materials in a suitable carrier liquid.

Printable compositions comprising the functional material can be provided on the relief image of the patterned material by applying them to the raised uppermost surfaces of the relief images. The functional material composition can be applied at any time after the patterned material is formed, for example within 24 hours or within as little as 10 minutes or after days or weeks. The functional material composition can be applied by any suitable method including the use of an anilox roller. The thickness of the applied printable composition on the patterned material is not particularly limited. In one embodiment, the printable composition wet thickness is typically less than the relief image height (that is, the difference between the uppermost surface and the recess floors).

The printable composition should be capable of forming a printable layer on the uppermost surfaces of the relief image. Beyond the elastomeric modulus of the relief image-forming elastomeric layer, certain other properties such as the solvent resistance of the patterned material, the boiling point of the solvent(s) or carrier liquid(s) in the printable composition and the solubility of the functional material in the solvent(s), can influence the capability of a certain functional materials to form a layer and be transferred as a pattern to a receiver element. It is well within the understanding of a skilled worker in the art to determine the appropriate combination of functional material, printable composition solvent(s), and relief image-forming elastomeric layer composition.

In some embodiments, after the printable composition has been applied to at least the uppermost surfaces of the relief image, the functional material in the printable composition is then at least partially (usually at least 50%) transferred to the receiver element to provide a pattern of the functional material in the printable composition corresponding to the relief image, to the receiver element.

In some other embodiments, after the printable composition has been applied to at least the uppermost surfaces of the relief image, the carrier liquid of the printable composition can be removed sufficiently to form a film of the functional material with minimal carrier liquid. Carrier liquid removal can be achieved in any manner, for example using gas jets, blotting with an absorbent material, evaporation or using convective air flow at room temperature or an elevated temperature, IR heat, or other means known in the art. In one embodiment, the carrier liquid can be removed by drying during the application of the functional material to the relief image. Effective drying can be assisted by selecting a carrier liquid(s) for the functional material that has a relatively low boiling point or by application of a very thin layer (for example, less than 1 μm) of the printable composition. The carrier liquid can be removed sufficiently to provide a pattern of the functional material corresponding to the relief image, to the receiver element. In one embodiment, a relatively dry film of the functional material in the printable composition on the patterned material has a thickness of at least 0.001 μm and up to and including 4 μm. In other embodiments, the relatively dry film functional material on the patterned material has a thickness of at least 0.1 μm and up to and including 2 μm.

In some embodiments, the functional material forms the printable composition as it is substantially free of carrier liquid to form a dry functional material film on the relief image. In other embodiments, the carrier liquid is substantially removed from the functional material composition to form a dried film of functional material on at least the uppermost surface of the relief image, and the dried film is exposed to a compound in its vaporized state in order to enhance transfer to a receiver element. The vaporized compound is not limited and can include water vapor or the vapor of an organic compound.

In still another embodiment, the patterned material can be used to form a pattern of a mask material on a receiver element. In this embodiment, the mask material can be considered as a functional material in a printable composition. That is, the mask material can be applied on at least the uppermost surfaces of the relief image and transferred to a receiver element to form a pattern or printed impression. The mask material should at least have the same capabilities as described above for a functional material, with the exception that the mask material does not facilitate an operation as an active material or an inactive material in a variety of components and devices. Materials suitable as a mask material are not limited provided that the mask material is capable of (1) forming a printable composition layer on at least the uppermost surfaces of the relief image of the patterned material, (2) transferring a pattern according to the relief image to the receiver element, and optionally (3) removing the pattern of functional material from the receiver element without damaging the receiver element.

In general, transferring the printable composition from the uppermost surfaces of a relief image to a receiver element creates a pattern of the functional material in the printable composition on the receiver element. The transferring can be referred to as “printing”. Contacting the functional material on the uppermost surfaces to the receiver element transfers the functional material, such that the pattern of functional material forms when the patterned material is separated from the receiver element. In one embodiment, most of the functional material positioned on the uppermost surfaces transfers to the receiver element. Separation of the patterned material from the receiver element can be accomplished using any suitable means.

Optionally, high pressure can be applied to the patterned material to assure contact and complete transfer of the printable composition to the receiver element. Transfer can be carried out by moving the uppermost surfaces of the relief image to the receiver element, by moving the receiver element to the uppermost surfaces of the relief image, or by moving both into contact relative with each other. In one embodiment, the printable composition is transferred manually. In another embodiment, the transfer of the printable composition is automated by for example, by a conveyor belt, reel-to-reel process, directly driven moving fixtures, chain, belt, or gear-driven fixtures, frictional roller, printing press, or rotary apparatus. The thickness of the layer of printable composition is not particularly limited with a typical thickness of the dry layer of functional material on the receiver element being at least 1 nm and up to and including 4000 nm.

While a particularly useful method of applying the printable composition to a receiver element is the use of flexography and a patterned flexographic printing member, the printable composition can also be applied to a receiver element using patterned gravure or intaglio printing members and printing methods.

The printing method can be carried out at room temperature such as at least 17° C. and up to and including 40° C. but the printing can be carried out at a lower temperature down to about 5° C., or at an elevated temperature up to 200° C. provided that the heat does not harm the patterned material, the printable composition, the receiver element, or the ability to form a pattern on the receiver element.

Printed patterns of printable compositions can be used in various industries to provide images, dots, text, and patterns of lines, shapes, or areas.

A printable composition can be applied to the receiver element surface using any suitable patterned material described herein. For example, the method of this invention can be used to provide a printed pattern comprising lines having an average line width of less than 20 μm, or typically fine lines having an average line width of less than 15 μm and generally at least 3 μm. These average values can be determined by measuring the line width in randomly selected locations in images captured from optical or scanning electron micrographs of appropriate magnification.

In some embodiments, the printing method provides a printed pattern of fine lines containing a seed material for a subsequent electroless plating process. For example, for copper electroless plating, such seed materials include but are not limited to, metals such as palladium, tin, and silver, or a mixture of tin and palladium, or corresponding metal salts.

In other embodiments, the printing method can be used to provide a pattern of fine lines having an electrical conductivity that is high enough for a subsequent electroplating process. Such an electrical conductivity is at least 0.1 S/cm and the details of such processes are known in the art.

In still other embodiments, the printing method can be used to provide a pattern of fine lines composed of a printable composition that is formulated to protect an underlying uniform metal film or conductive film during a subsequent etching process. For example, the printable composition can be formulated to protect an underlying copper or silver film during a subsequent etching process.

In some embodiments, a laser-engraved patterned material can have a relief image comprising a predetermined pattern of relief lines, each line having an average width of at least 1 μm and up to and including 10 mm. Such lines can also have an average height of at least 10 μm and up to and including 4,000 μm. These average dimensions can be determined by measuring the lines in at least 10 places and determining the width or height using known image analysis tools including but not limited to, profilometry, optical microscopic techniques, atomic force microscopy, and scanning electron microscopy.

A receiver element to be printed can be composed of any suitable material including but are not limited to, polymeric films, metals, silicon or ceramics, fabrics, papers, cardboard, and combinations thereof provided that a pattern of a functional material can be formed thereon. The receiver element can be transparent or opaque, and rigid or flexible. The receiver element can include one or more layers or one or more patterns of other materials before the pattern of printable composition is applied. The surface of the receiver element can be treated for example with a primer layer, to promote adhesion of the functional material or to promote adhesion of a separate adhesive layer on a receiver element substrate. An adhesive layer can be disposed on a substrate in the receiver element and this adhesive layer can have various properties in response to heat (thermally activatable) that aids in the adhesion of the pattern of functional material in the printable composition. Useful adhesive materials of this type are described for example in [0057] of U.S. Patent Application 2008/0233280 (noted above).

The substrates can be surface-treated by exposure to corona discharge, mechanical abrasion, flame treatments, or oxygen plasmas, or by coating with various polymeric films, such as poly(vinylidene chloride) or an aromatic polysiloxane as described for example in U.S. Pat. No. 5,492,730 (Balaba et al.) and U.S. Pat. No. 5,527,562 (Balaba et al.) and U.S. Patent Application Publication 2009/0076217 (Gommans et al.).

Suitable substrates in the receiver elements include but are not limited to, metallic films or foils, metallic films on polymer, glass, flexible glass, or ceramic supports, metallic films on electrically conductive film supports, semi-conducting organic or inorganic films, or organic or inorganic dielectric films. For example, useful substrates can include indium-tin oxide coated glass, indium-tin oxide coated polymeric films, poly(ethylene terephthalate) films, poly(ethylene naphthalate) films, polyimide films, polycarbonate films, polyacrylate films, polystyrene films, polyolefin films, polyamide films, silicon, metal foils, cellulosic papers or resin-coated or glass-coated papers, glass or glass-containing composites, ceramics, metals such as aluminum, tin, and copper, and metalized films. The receiver element substrate can also include one or more charge injection layers, charge transporting layers, and semi-conducting layers on which the printable composition pattern is formed.

Particularly useful substrates are polyesters such as poly(ethylene terephthalate), poly(ethylene naphthalene), polycarbonate, or poly(vinylidene chloride) films that have been surface-treated as noted above.

After the pattern of printable composition has been applied to the receiver element in a suitable manner, the pattern can be further treated if desired using heat or exposure to actinic radiation (such as UV, visible, or IR radiation). For example, if the printable composition contains metal nanoparticles, the pattern of printable composition can be heated to sinter the particles and render pattern lines conductive. Sintering provides a coherent bonded mass from heating a metal powder in the form of metal nanoparticles and without melting. Sintering can be carried out using temperatures and conditions that would be apparent to one skilled in the art.

The following Examples are provided to illustrate the practice of this invention and are not meant to be limiting in any manner.

Certain materials used in the Examples were prepared as follows:

Preparation of Sol Precursor A:

Tetraethyl orthosilicate (TEOS, Eastman Kodak Company) (10 ml) and ethanol (10.5 ml) were stirred in a capped container. Water (1.6 ml) and hydrochloric acid (140 μl) were then added to the mixture. The solution was stirred for an hour at room temperature. (1H,1H,2H,2H-heptadecafluorodecyl)-trichlorosilane (770 μl, Gelest Inc.) was then added to the reaction mixture and it was stirred for another hour. The final solution was then diluted with 154 ml of ethanol prior to coating. This provided a molar ratio of the of non-fluorinated metal (such as silicon) oxide precursors to hydrolyzable fluoroalkylsilane of 1:0.05.

Preparation of Sol Precursor B:

The same preparation was carried out as described for the Preparation of Sol precursor A except that 154 μl of (1H,1H,2H,2H-heptadecafluorodecyl)trichlorosilane was used. This provided a molar ratio of the of non-fluorinated metal (such as silicon) oxide precursors to hydrolyzable fluoroalkylsilane of 1:0.01.

Preparation of Sol Precursor C:

The same preparation was carried out as described for Sol precursor A except that 15.4 μl of (1H,1H,2H,2H-heptadecafluorodecyl)-trichlorosilane was used. This provided a molar ratio of the of non-fluorinated metal (such as silicon) oxide precursors to hydrolyzable fluoroalkylsilane of 1:0.001.

Preparation of Sol Precursor D:

The same preparation was carried out as described for Sol precursor A except that no (1H,1H,2H,2H-heptadecafluorodecyl)trichlorosilane was used.

Preparation of Sol Precursor E:

Sol precursor A (5 ml) was mixed with 100 μl of a 2.5 weight % solution of poly(vinyl butyral) (Butvar® 72 from Solutia, Incorporated) in ethanol, providing a composition containing polymer at 2.68 weight %, based on the total weight of the dry layer.

Preparation of Sol Precursor F:

Sol precursor A (5 ml) was mixed with 1 ml of a 2.5 weight % solution of Butvar® 72 in ethanol, providing a composition containing polymer at 21.65 weight %, based on the total weight of the dry layer.

Preparation of Sol Precursor G:

(1H,1H,2H,2H-Heptadecafluorodecyl)trichlorosilane (250 μl) and ethanol (4 ml) were stirred in a capped container. Water (26.3 μl) and hydrochloric acid (7 μl) were then added to the mixture. The solution was stirred for an hour at room temperature.

Preparation of Sol Precursor H:

Tetramethyl orthosilicate (TMOS) (10 ml) and ethanol (15.8 ml) were stirred in a capped container. Water (2.4 ml) and hydrochloric acid (140 μl) were then added to the mixture. The solution was stirred for an hour at room temperature. (1H,1H,2H,2H-heptadecafluorodecyl)trichlorosilane (1.16 ml) was then added to the reaction mixture and was stirred for another hour. This provided a molar ratio of the of non-fluorinated silicon oxide precursor to hydrolyzable fluoroalkylsilane of 1:0.05.

The water contact angle of the various surfaces described below was determined using a Rame-Hart contact angle goniometer (Model 100-00115) at ambient conditions.

### Comparative Example 1

An untreated Kodak Flexcel NX printing plate precursor, having an elastomeric layer adhered to a poly(ethylene terephthalate) support, the elastomeric layer was imaged with a pattern of 10 μm wide lines that were arranged in a cross-hatch pattern, and with other image features including 100% solid area patches, and processed to form a relief image. The patterned flexographic printing plate precursor was cleaned using a household cleaning detergent and water, rinsed with isopropyl alcohol (IPA), and dried with air prior to its use for printing.

### Comparative Example 2

The patterned flexographic printing plate described in Comparative Example 1 was immersed in Sol Precursor D, removed, and dried in air overnight. The flexographic printing plate was then cured at 120° C. for 2 hours prior to cleaning test experiments. The water contact angle for its surface is shown below in TABLE I.

### Comparative Example 3

The patterned flexographic printing plate described in Comparative Example 1 was immersed in Sol Precursor G, removed, and dried in air overnight. The flexographic printing plate was then cured at 120° C. for 2 hours prior to cleaning test experiments. The water contact angle for its surface is shown below in TABLE I.

### Invention Example 1

### Coating Entire Patterned Material Relief Image

A sample of the Kodak Flexcel NX flexographic printing plate precursor was imaged as described in Comparative Example 1 to form a patterned flexographic printing plate having a relief image. Scotch® brand adhesive tape was placed on the backside (non-imaged side) of the flexographic printing plate to protect it. The patterned flexographic printing plate was then immersed in Sol Precursor A (described above) as a reactive composition, removed, dried in air overnight, and cured at 120° C. for 2 hours in an air oven prior to use for printing.

The water contact angle of this patterned flexographic printing plate (with the grid 10 um grid patterns) was measured to be about 120°. The water contact angle measured after the same treatment a non-patterned (non-imaged) Flexcel NX flexographic printing plate precursor (flat surface [solid patch area]) using Sol Precursor A was measured to be 107°. This difference can be attributed to the roughness introduced by the crosshatch patterns of the flexographic printing plate.

The water contact angle of the non-treated portions of the Comparative Example 1 flexographic printing plate was measured to be about 74°. The higher water contact angle obtained for the treated patterned material of Invention Example 1, in both imaged and non-imaged areas, is predictive of its easier cleanability. Thus, the higher the water contact angle, the more easily the surface is cleaned and less ink residue is retained. An important observation is that the desired surface property is preserved even at low concentrations of Sol Precursor A.

### Invention Example 2

### Coating Entire. Patterned Material Relief Image

The patterned flexographic printing plate described in Comparative Example 1 was immersed in Sol Precursor B as a reactive composition, removed, and dried in air overnight. The treated flexographic printing plate was then cured at 120° C. for 2 hours prior to the cleaning test experiments described below. The water contact angle on the treated flexographic printing plate surface is shown below in TABLE 1.

### Invention Example 3

### Coating Entire Patterned Material Relief Image

The patterned flexographic printing plate described in Comparative Example 1 was immersed in Sol Precursor C as a reactive composition, removed, and dried in air overnight. The treated flexographic printing plate was then cured at 120° C. for 2 hours prior to the cleaning test experiments. The water contact angle on the treated flexographic printing plate surface is shown below in TABLE I.

### Invention Example 4

### Coating Entire Patterned Material Relief Image

The patterned flexographic printing plate described in Comparative Example 1 was immersed in Sol Precursor E as the reactive composition, removed, and dried in air overnight. The treated flexographic printing plate was then cured at 120° C. for 2 hours prior to the cleaning test experiments. The water contact angle on the treated flexographic printing plate surface is shown below in TABLE 1.

### Invention Example 5

### Coating Entire Patterned Material Relief Image

The patterned flexographic printing plate described in Comparative Example 1 was immersed in Sol Precursor F as the reactive composition, removed, and dried in air overnight. The treated flexographic printing plate was then cured at 120° C. for 2 hours prior to the cleaning test experiments. The water contact angle on the treated flexographic printing plate surface is shown below in TABLE I.

### Invention Example 6

### Coating Entire Patterned Material Relief Image

The patterned flexographic printing plate described in Comparative Example 1 was immersed in Sol Precursor H as the reactive composition, removed, and dried in air overnight. The treated flexographic printing plate was then cured at 120° C. for 2 hours prior to the cleaning test experiments. The water contact angle on the treated flexographic printing plate surface is shown below in TABLE I.

TABLE I
Water Contact Angle on the Grid Areas

| Patterned Material | Reactive Composition | Water Contact Angle |
|---|---|---|
| Invention Example 1 | A | 120° |
| Invention Example 2 | B | 100° |
| Invention Example 3 | C | 100° |
| Invention Example 4 | E | 120° |
| Invention Example 5 | F | 115° |
| Invention Example 6 | H | 120° |
| Comparative Example 1 | None | 74° |
| Comparative Example 2 | D | 82° |
| Comparative Example 3 | G | 95° |

The results shown in TABLE I indicate that the treatment of the patterned material with the reactive composition changes the wetting property of the printing surface, and depends upon the ratios between the reactants non-fluorinated silicon alkoxide precursor and the hydrolyzable fluoroalkylsilane. This change in surface energy was measured by the change in water contact angle and affects the cleaning ability of the patterned materials as shown in the following Examples. A printing surface showing a higher contact angle is easier to clean. It is also important to note that these contact angles remain unexpectedly lower than 140°. A higher contact angle than about 140° would decrease the wetting of the ink onto the uppermost relief surfaces to the extent that would adversely affect printing quality.

### Invention Example 7

### Coating Only Recess floors and Walls of Relief Image

To provide a patterned material where the reactive composition comprising a reaction product of a non-fluorinated metal oxide precursor and a hydrolyzable fluoroalkyl silane is disposed on only the recess walls and recess floors of the elastomeric layer in the relief image, the uppermost surfaces of the relief image were protected in some manner.

A sample of the Kodak Flexcel NX patterned flexographic printing plate having a relief image described in Comparative Example 1 was treated with a polymer [such as cellulose acetate butyrate (CAB) from Eastman Chemical Company] mask (protective layer) in the following manner. A thin wet layer of a 1% solution of CAB in acetone/2-methyl-2,4-pentanediol (MPD) was applied to a poly(ethylene terephthalate) film, and the patterned flexographic printing plate was rolled over the wet CAB layer, thus wetting and coating primarily the uppermost surfaces of the patterned flexographic printing plate. This operation was followed by drying the patterned flexographic printing plate. The patterned flexographic printing plate was then immersed in Sol Precursor A as the reactive composition and dried in air overnight, and the CAB mask was rinsed off the uppermost surfaces of the relief image using acetone, which did not affect the dried Sol Precursor A coated on the recess floors and walls of the relief image.

### Invention Example 8

### Cleanability Tests

The non-treated patterned Flexcel NX flexographic printing plate described in Comparative Example 1 and the treated patterned flexographic printing plates described in Comparative Examples 2-3 and Invention Examples 1-6 were heavily inked, wherein the ink covered the uppermost surfaces and the relief recesses comprising recess walls and recess floors, with each of the following different inks as printable compositions [aqueous cyan ink (HydrofilmACE (HMR50080-473) process CYAN from FlintGroup), solvent cyan ink (Flint Thermogloss Cyan, batch 116266), solvent-based silver nanoparticle ink (TEC-PR-030 from InkTec Corporation), and an aqueous-based silver nanoparticle ink (PFI-722 from PChem. Assoc. Inc.)]. The inks were dried under ambient conditions for a period of time from about 30 seconds to 12 hours, and then each flexographic printing plate was rinsed by spraying it with the appropriate cleaning materials (organic solvent, water, or water with a household cleaning detergent such as Fantastic® household cleaner). The cleanability of each inked flexographic printing plate was rated from 1 to 5, where 5 represents the easiest to clean and 1 indicates no cleaning was possible using this procedure. The results of the cleanability tests are shown below in TABLE II.

TABLE II
Cleanability Test Results Using Various Inks

| | | | | Aqueous | |
|---|---|---|---|---|---|
| | | Aqueous | | Silver Ink | Aqueous |
| | Aqueous | Cyan Ink | | (PChem) | Silver Ink |
| | Cyan Ink | Water & | Solvent | Water and | (InkTec) |
| Patterned | Water | Fantastic ® | Cyan Ink | Fantastic ® | Isopropanol |
| Material | Only | Detergent | Acetone | Detergent | (IPA) |
| Invention | 5 | 5 | 5 | 5 | 4 |
| Example 1 | | | | | |
| Invention | 4 | 5 | 3 | Not done | Not done |
| Example 2 | | | | | |
| Invention | 4 | 5 | 3 | Not done | Not done |
| Example 3 | | | | | |
| Invention | 5 | 5 | 5 | Not done | Not done |
| Example 4 | | | | | |
| Invention | 4 | 5 | 5 | Not done | Not done |
| Example 5 | | | | | |
| Invention | 5 | 5 | 5 | Not done | Not done |
| Example 6 | | | | | |
| Comparative | 3 | 4 | 1 | 3 | 1 |
| Example 1 | | | | | |
| Comparative | 4 | 5 | 2 | Not done | Not done |
| Example 2 | | | | | |
| Comparative | 4 | 5 | 1 | Not done | Not done |
| Example 3 | | | | | |

These results shown in TABLE II demonstrate that the treated patterned flexographic printing plates of the present invention are much easier to clean, and required less abrasive cleaning procedures compared to the non-treated patterned flexographic printing plates of the Comparative Examples. This improvement provided by the present invention increases printing life. Since the non-treated flexographic printing plates could not be cleaned of ink (printable composition) readily by simple spraying on the household detergent cleaning solution, scrubbing, using abrasive actions, or other severe cleaning procedures are then required. Such severe cleaning processes will wear away the relief image and printing surface more quickly.

It was also observed that even after brushing the non-treated patterned flexographic printing plates, their final appearance was comparable with the non-brushed and rinsed only treated relief image areas, signifying that brushing the patterned flexographic printing plate can be avoided during the cleaning step when the plate was treated according to the present invention. This advantage can significantly help prevent damage to the patterned material that can be caused by harsh scrubbing, and thereby greatly simplifies cleaning ink or other printable compositions from the patterned material.

### Invention Example 9

### Printing with Aqueous Cyan Ink

Three separate sections of a patterned Flexcel NX flexographic printing plate precursor (Eastman Kodak Company) as described in Comparative Example 1 were treated as follows: (a) one section left untreated (as in Comparative Example 1), (b) a second section in which only the relief image recess walls and recess floors were treated with Sol Precursor A as a reactive composition (as in Invention Example 7), and (c) a third section in which the entire relief image was treated with Sol Precursor A as a reactive composition (as in Invention Example 1). The patterned flexographic printing plate was then mounted onto a tabletop test printer (IGT F1 printability tester from IGT Testing Systems, Inc. in the flexographic mode) using a Lohmanns yellow mounting tape (soft) and used to print with an aqueous cyan ink (HydrofilmACE (HMR50080-473) process CYAN from FlintGroup) as a printable composition. The receiver element used during printing was a poly(ethylene terephthalate) film that had been coated with a copolymer derived from acrylonitrile, vinyl chloride, and acrylic acid, which copolymer was then dried to provide a coverage of 10 mg/ft² (108 mg/m²). The entire patterned flexographic printing plate was rinsed with a household cleaning detergent in water after every printing impression. The printing impression quality was rated from 1 to 3, wherein 1 represented the poorest print impression quality (discontinuous lines and blotchy solids) and 3 represented the best print impression quality (continuous lines and solid areas in prints). These results are summarized in TABLE III below.

### Invention Example 10

### Printing with Solvent Cyan Ink

The middle section only of another imaged Flexcel NX printing plate precursor (as described in Comparative Example 1) was treated with Sol Precursor A as a reactive composition, leaving the two end sections of the patterned flexographic printing plate untreated. The partially treated patterned flexographic printing plate was mounted onto a tabletop test printer (IGT F1 printability tester in the flexographic mode) using a 3M pink mounting tape (1915H) and used to print with a solvent-based cyan ink (Flint Thermogloss Cyan, batch 116266) as a reactive composition. The receiver element used during printing was the same as that described above in Invention Example 9. The entire patterned flexographic printing plate was rinsed with acetone after every printing impression and the printing impression quality was rated as described in Invention Example 9. The results are summarized below in TABLE III.

### Invention Example 11

### Printing with Solvent-based Silver Ink

A treated patterned Flexcel NX flexographic printing plate like that described in Invention Example 10 was mounted onto a tabletop test printer (IGT F1 printability tester in the flexographic mode (IGT printer) using a 3M pink mounting tape (1915H) to print a commercial solvent based silver nanoparticle ink (TEC-PR-030 from InkTec Corporation) as a printable composition. The receiver element used during printing was the same as that described in Invention Example 9. The entire patterned flexographic printing plate was rinsed after every printing impression using isopropyl alcohol. Printing impression quality was evaluated as described above in Invention Example 9 and the results are summarized below in TABLE III.

TABLE III
Printing Impression Quality Ratings

| | Print Quality | | | | |
|---|---|---|---|---|---|
| Patterned | Fine Lines (<50 μm) | | | Solid Patch Area | |
| Material | Invention | Invention | Invention | Invention | Invention |
| Section of | Example | Example | Example | Example | Example |
| Plate | 9 | 10 | 11 | 9 | 10 |
| Untreated | 3 | 1 | 3 | 2 | 1 |
| as in | | | | | |
| Comparative | | | | | |
| Example 1 | | | | | |
| Treated | 3 | 2 | 3 | 2 | 1 |
| as in | | | | | |
| Invention | | | | | |
| Example 1 | | | | | |
| Treated | 3 | Not done | Not done | Not done | Not done |
| as in | | | | | |
| Invention | | | | | |
| Example 7 | | | | | |

These results demonstrate that the quality of the printing impressions was not adversely affected by the treatment with a reactive composition in the patterned flexographic printing plates according to the present invention.

### Invention Example 12

### Transfer Printing

A sample of a Flexcel NX flexographic plate, treated in the middle section as described in Invention Example 10 was mounted onto the print form cylinder of an IGT printer using a Lohmanns yellow mounting tape. The flexographic printing plate was inked with a silver nanoparticle aqueous ink from PChem. Assoc. Inc. (PFI-722 Lot 102212) as a printable composition using an anilox roll. The silver nanoparticle aqueous ink on the patterned flexographic printing plate was substantially dried at ambient conditions by printing slowly, and it was subsequently transferred onto a receiver element that was heated to 106° C. in each printing impression. The receiver element was a poly(ethylene terephthalate) film that had been coated with a copolymer derived from acrylonitrile, vinyl chloride, and acrylic acid, which copolymer was then dried to provide a coverage of 100 mg/ft² (1080 mg/m²). The entire patterned and inked flexographic printing plate was rinsed (but not scrubbed) after every printing impression by spraying it with a household cleaning detergent in water. Five print impressions were made using the same procedure. Print impression quality (“line quality”) was evaluated after the 5^{th} print impression and rated from 1 to 3 wherein 1 represented the poorest print quality (discontinuous lines) and 3 represented the best print quality (continuous lines).

Print line broadening due to ink build-up on the patterned flexographic printing plate was measured after the 5^{th} printing impression. In addition, the plate cleanliness after the 5^{th} printing impression was evaluated and rated from 1 to 4 wherein 1 represented the heaviest accumulation of ink on the uppermost surfaces and 4 represented the least accumulation of ink on the uppermost surfaces. These evaluations are summarized below in TABLE IV.

### Invention Example 13

### Transfer Printing of Aqueous-Based Silver Ink with No Cleaning Step Between Printing Impressions (Multi-Print)

The same flexographic printing plate, silver nanoparticles aqueous ink (printable composition), and printing procedure as described in Invention Example 12 were used except that no cleaning step was performed after every printing impression, and 10 repeat printing impressions were made. The quality of the print impressions, the line widths, and the cleanliness of the patterned flexographic printing plate were also evaluated after the 10^{th} printing impression, and the results are summarized below in TABLE IV.

TABLE IV
Print Quality

| | Invention Example 12 | | | Invention Example 13 | | |
|---|---|---|---|---|---|---|
| | | Average | | | Average | |
| | Line | Line | | Line | Line | |
| | Quality | Width | Plate | Quality | Width | Plate |
| Section of | after the | after 5^{th} | Cleanliness | after the | after 10^{th} | Cleanliness |
| Printing | 5^{th} | Impression | after 5^{th} | 10^{th} | Impression | after 10^{th} |
| Plate | Impression | (μm) | Impression | Impression | (μm) | Impression |
| Untreated | 3 | 21 | 1 | 2 | 20 | 1 |
| (like | | | | | | |
| Comparative | | | | | | |
| Example 1) | | | | | | |
| Treated (like | 3 | 12 | 4 | 2 | 11.5 | 4 |
| Invention | | | | | | |
| Example 1) | | | | | | |

These results shown in TABLE IV demonstrate that using the treated patterned flexographic printing plate did not adversely affect the quality of the ink prints (impressions) but provided the advantage of keeping the patterned flexographic printing plate clean from silver ink residues. Moreover, broadening of the printed lines was impeded during the successive impressions with the use of the treated patterned flexographic printing plate because less silver ink build-up was observed.

The invention has been described in detail with particular reference to certain preferred embodiments thereof, but it will be understood that variations and modifications can be effected within the spirit and scope of the invention.

1. A patternable material comprising:
a relief image-forming elastomeric layer, and
a layer disposed on the relief image-forming elastomeric layer, the layer comprising a reaction product of a non-fluorinated metal oxide precursor and a hydrolyzable fluoroalkylsilane.

2. The patternable material of claim 1, wherein the layer disposed on the relief image-forming elastomeric layer comprises an acid-catalyzed reaction product of a non-fluorinated silicon alkoxide precursor and a hydrolyzable fluoroalkylsilane.

3. The patternable material of claim 1, wherein the non-fluorinated metal oxide precursor for the reaction product comprises at least three hydrolyzable groups per metal atom, wherein the hydrolyzable groups are selected from the group consisting of halogen, alkoxy, aryloxy, and carboxy groups.

4. The patternable material of claim 1, wherein the hydrolyzable fluoroalkylsilane for the reaction product is represented by the formula:
R¹-R²—Si(X)₃
wherein R¹ is a fluoroalkyl group, R² is an aliphatic linking group connecting the fluoroalkyl group to Si, and X is a hydrolyzable group selected from the group consisting of halogen, alkoxy, aryloxy, and carboxy groups.

5. The patternable material of claim 1, wherein the layer disposed on the relief image-forming elastomeric layer comprises an acid-catalyzed reaction product of a non-fluorinated silicon oxide precursor and a hydrolyzable fluoroalkylsilane, and this layer has a dry thickness of at least 100 nm and up to and including 5,000 nm.

6. The patternable material of claim 1 that is a flexographic, intaglio, or gravure printing member having a plate, sleeve, or cylinder format.

7. The patternable material of claim 1, wherein the relief image-forming elastomeric layer is disposed on a non-relief image-forming substrate.

8. The patternable material of claim 1, wherein the layer disposed on the relief image-forming elastomeric layer further comprises a polymer binder in an amount of up to and including 20 weight %, based on the total layer dry weight.

9. A method for providing a patterned material useful for printing, the method comprising:
providing a patternable material precursor comprising a relief image-forming elastomeric layer,
applying a reactive composition comprising a non-fluorinated metal oxide precursor and a hydrolyzable fluoroalkylsilane over the entire surface on the relief image-forming elastomeric layer,
drying and curing the reactive composition to form a layer comprising a reaction product of a non-fluorinated metal oxide precursor and a hydrolyzable fluoroalkylsilane, and
providing a relief image comprising uppermost surfaces and relief recesses comprising recess walls and recess floors, and simultaneously removing the reaction product from the relief recesses while leaving the reaction product disposed only on the uppermost surfaces,
to form a patterned material useful for printing.

10. The method of claim 9, comprising:
providing the relief image by direct laser ablation.

11. The method of claim 9, wherein the reactive composition comprises an acid-catalyzed non-fluorinated silicon oxide precursor and a hydrolyzable fluoroalkylsilane.

12. The method of claim 9, wherein the non-fluorinated metal oxide precursor in the reactive composition comprises at least three hydrolyzable groups per metal atom, wherein the hydrolyzable groups are selected from the group consisting of halogen, alkoxy, aryloxy, and carboxy groups.

13. The method of claim 9, wherein the hydrolyzable fluoroalkylsilane in the reactive composition is represented by the formula:
R¹-R²—Si(X)₃
wherein R¹ is a fluoroalkyl group, R² is an aliphatic linking group connecting the fluoroalkyl group to Si, and X is a hydrolyzable group selected from the group consisting of halogen, alkoxy, aryloxy, and carboxy groups.

14. The method of claim 9, wherein the reactive composition comprises an acid-catalyzed reaction product of a non-fluorinated silicon oxide precursor and a hydrolyzable fluoroalkylsilane, and the reactive composition is applied, dried, and cured to provide a layer of the reaction product that has a dry thickness of at least 100 nm and up to and including 5,000 nm.

15. The method of claim 9, wherein drying and curing is carried out at a temperature of at least 50° C. and up to and including 200° C.
